(19) United States
(12) Patent Application Publication
(10) Pub. No.: US 2009/0116266 A1
(43) Pub. Date: May 7, 2009

(54) PARALLELED POWER CONDITIONING SYSTEM WITH CIRCULATING CURRENT FILTER

(75) Inventors: Jih-Sheng LAI, Taipei (TW); Min-Hsien Lin, Taipei (TW); Hung-Wen Chen, Taipei (TW); Yu-Hsuan Liu, Taipei (TW); Feng-Yuan Lin, Taipei (TW); Chien-Liang Chen, Taipei (TW)

Correspondence Address: LOWE HAUPTMAN HAM & BERNER, LLP, 1700 DIAGONAL ROAD, SUITE 300, ALEXANDRIA, VA, 22314, US

(73) Assignee: Tatung Company, Taipei (TW)

(21) Appl. No.: 12/056,677

(22) Filed: Mar. 27, 2008

(30) Foreign Application Priority Data
Nov. 2, 2007 (TW) 096141598

(51) Int. Cl. H02M 1/12

(52) U.S. Cl. 363/40

(57) ABSTRACT

This present invention relates to a paralleled power conditioning system with circulating current filter, comprising: an input terminal for receiving a input power; a plurality of power conditioning units; and a load. Each power conditioning unit includes: a DC/DC converter coupled to the input for receiving the input power so as to convert the input power to a DC voltage; a DC/AC inverter coupled to the DC/DC converter for converting the DC voltage to a AC voltage; and a filter coupled to the DC/AC inverter for eliminating the noise generated by the AC voltage and the circulating current among the plurality of power conditioning units so as to generate a filter voltage. The load is connected to the plurality of power conditioning units. The plurality of power conditioning units are connected in parallel to the load.

### RELATED APPLICATIONS

The present application is based on, and claims priority from, Taiwan Application Number 096141598, filed Nov. 2, 2007, the disclosure of which is hereby incorporated by reference herein in its entirety.

### BACKGROUND OF THE INVENTION

1. Field of the Invention

The present invention relates to a power conditioning system and, more particularly to a paralleled power conditioning system with a filter capable of filtering out the circulating current.

2. Description of Related Art

The paralleled inverter has been developed for a long time to the power supply and the uninterruptible power system (UPS). FIG. 1 shows a diagram of the conventional power conditioning system, which uses the inductor and the capacitor to perform filtering. Referring to FIG. 1, the power 110 outputs a voltage and a current to a load 150 through a plurality of power conditioning systems 120. The power conditioning system 120 comprises a DC/DC converter 130, and a DC/AC inverter 140. Each power conditioning system 120 connects with each other in parallel respectively.

The DC/DC converter 130 can arise the output voltage Vin of the power 110 to a high voltage Vdc by separating transformer. FIG. 2 shows a circuit diagram of the DC/DC converter 130 such as a full-bridge converter 130. Referring to FIG. 2, the full-bridge converter 130 is composed of four switches S1, S2, S3 and S4. While the switches S1 and S4 are both kept at power on status, the voltage crossed through the transformer 131 will be kept at a positive value. While the switches S2 and S3 are both kept at power on status, the voltage crossed through the transformer 131 will be kept at a negative value. The transformer 131 can transform the voltage by switching the switches (S1, S4) and (S2, S3). According to the transforming ratio 1:n of the transformer 131, the secondary side voltage of the transformer 131 is n times of the primary side voltage. The switching frequency of the DC/DC converter 130 will be changed by the transformer 131, and the frequency is generally kept between 10 to 100K Hz. The diode bridge circuit 133 composed of the diodes D1, D2, D3 and D4 rectifies a high frequency AC voltage to a DC voltage. The output of the diode bridge rectifier circuit 133 connects to an inductor Lf and a capacitor Cf for performing filtering to generate a clear DC voltage Vdc. Ideally, the voltage Vdc is n times of the Vin, but the Vdc is always less than n times of Vin due to the loss and duty cycle of the circuit.

In high efficient power system application, the full-bridge DC/DC converter 130 needs high volume elements such as switches, input capacitor Cin, inductor Lf and capacitor Cf to increase transforming efficiency, but the high volume elements will cause some inconvenient problems such as cost increasing or thermal performance. For solving the aforementioned problems, a multi-phase converter is used to reduce load of the switches and size of the passive components. FIG. 3 is a schematic view illustrating a conventional three-phase DC/DC converter. The three-phase DC/DC converter needs six switches capable of separating to three phases such as (S1, S4), (S3, S6), and (S5, S2). The on/off times for the two switches of each phase are complementary to each other, and each phase differs 120 degree with each other for reducing high frequency ripple significantly, so as to decrease the volume of the passive components such as the input capacitor Cin, inductor Lf or capacitor Cf.

The conventional DC/AC inverter 140 is a full-bridge circuit. FIG. 4(A) shows a full-bridge DC/AC inverter 140 with a single AC output, which is composed of four switches Q1, Q2, Q3 and Q4. The inverter 140 uses SPWM (Sine-wave Pulse Width Modulation) to control the switches Q1-Q4 for changing pulse-width in every switching period so as to generate a square-form wave, and then an output voltage V0 will be generated by performing LC filtering. FIG. 4(B) shows a full-bridge DC/AC inverter 140 with two AC outputs. For generating two AC voltage outputs, the input voltage Vdc is separated to two equal DC voltages (Vdc/2), and the voltage output at the midpoint of the transformer 140 becomes the neutral point which outputs a voltage of vo/2, and therefore the total AC output voltage is vo.

In paralleled DC/AC inverter system, the connecting portion formed on the system is the output of the DC/AC inverter, and all of the output capacitors will be connected in parallel. Due to the output voltage of the capacitor is equal to the power voltage source, and therefore a small voltage difference will probably generate a huge circulating current. At that time, it is difficult to connect the power source to the utility grid, and therefore the conventional system comprises a coupled inductor disposed between two different inverters for preventing from generating a circulating current. FIG. 5 is a schematic view illustrating a conventional power conditioning system using a coupled inductor to connect two inverters. Referring to FIG. 5, the outputs of two inverters are connected to same inductor L, i.e., the primary side and the secondary side are coupled together, and such a filtering with which the inductor is placed in front of the capacitor is a so-called LC type filter. FIG. 6(A) is a schematic view of the conventional coupled inductor structure. FIG. 6(B) shows a circuit diagram of the conventional coupled inductor structure. Referring to FIG. 6(A), the coupled inductors can be stacked for increasing the number of output pin, but all of the inverters should be connected to the same coupled inductor, and therefore the circulating current is still generated by the aforementioned method.

### SUMMARY OF THE INVENTION

This present invention provides a paralleled power conditioning system with a specific filter for reducing circulating current effectively.

For achieving the object, this present invention provides a paralleled power conditioning system with circulating current filter, comprising: an input terminal for receiving an input power; a plurality of power conditioning units each including: a DC/DC converter coupled to the input terminal for receiving the input power so as to convert to a stable DC voltage; a DC/AC inverter coupled to the DC/DC converter for converting the DC voltage to a AC voltage; and a filter coupled to the DC/AC inverter for eliminating the noise generated by the AC voltage and the circulating current among the power conditioning units, so as to generate a filter voltage; and a load connected to the plurality of power conditioning units, wherein, the plurality of power conditioning units are connected in parallel to the load.

Other objects, advantages, and novel features of the invention will become more apparent from the following detailed description when taken in conjunction with the accompanying drawings.

### BRIEF DESCRIPTION OF THE DRAWINGS

FIG. 1 shows a diagram of the conventional paralleled power conditioning system.

FIG. 2 shows a circuit diagram of the full-bridge DC/DC converter.

FIG. 3 shows a schematic view illustrating a conventional three-phase DC/DC converter.

FIG. 4(A) shows a full-bridge DC/AC inverter with a single AC output.

FIG. 4(B) shows a full-bridge DC/AC inverter with dual AC outputs.

FIG. 5 shows a conventional power conditioning system using a 15 coupled inductor to connect paralleled inverters.

FIG. 6(A) is a schematic view illustrating the conventional coupled inductor structure.

FIG. 6(B) is a circuit diagram of the conventional coupled inductor structure.

FIG. 7 is a schematic view illustrating a paralleled power conditioning system using the uncoupled LCL type filter.

FIG. 8 shows another embodiment illustrating a paralleled power conditioning system using a coupled LCL type filter of the present invention.

FIG. 9 is a schematic view illustrating a simulation result of the FIG

FIG. 10 is a schematic view illustrating the magnified circulating current of the FIG. 9.

FIG. 11 is a schematic view illustrating the simulation result of the FIG. 8.

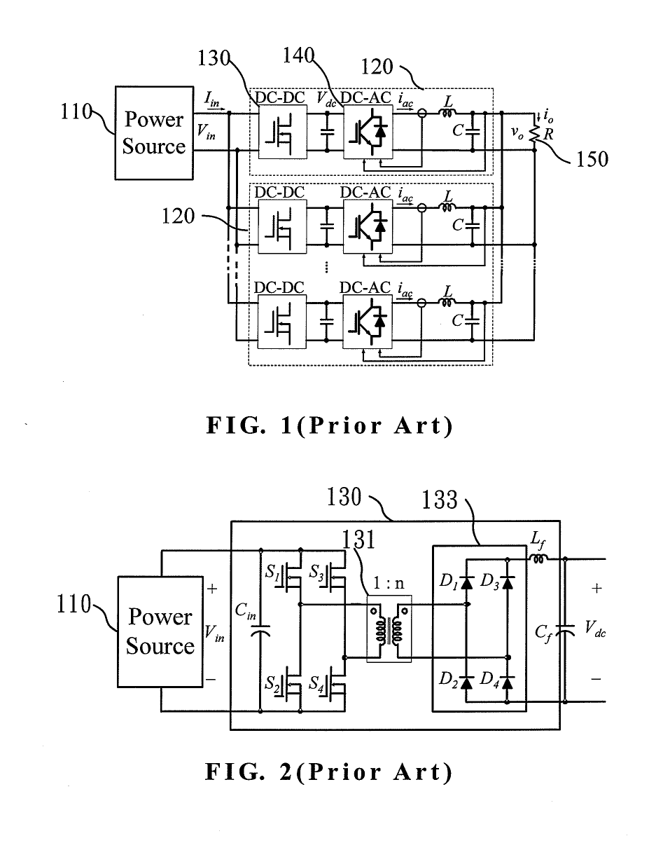

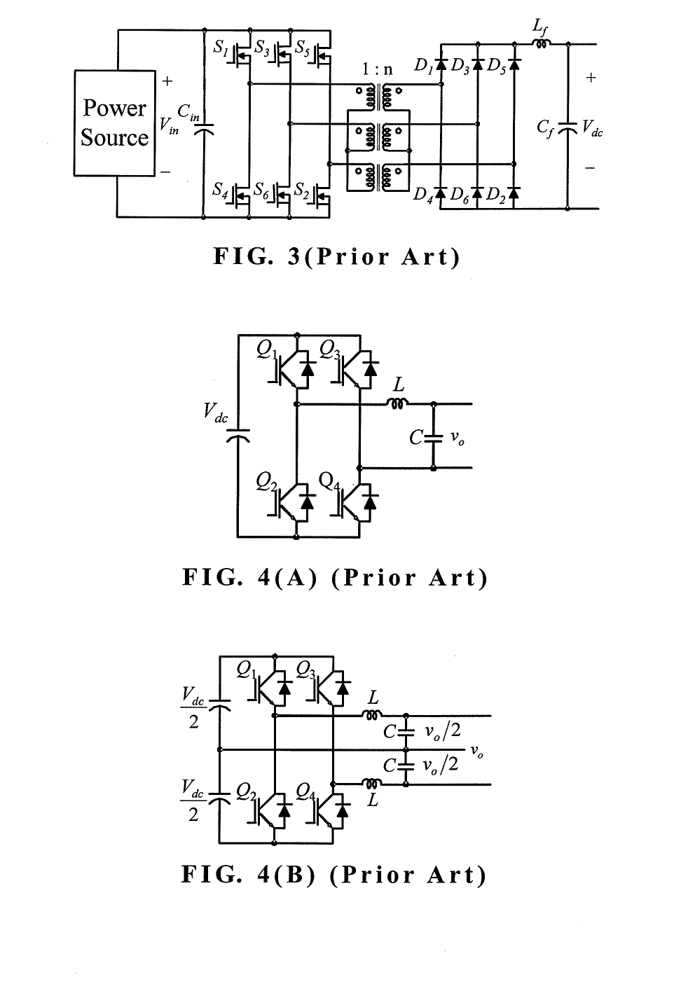

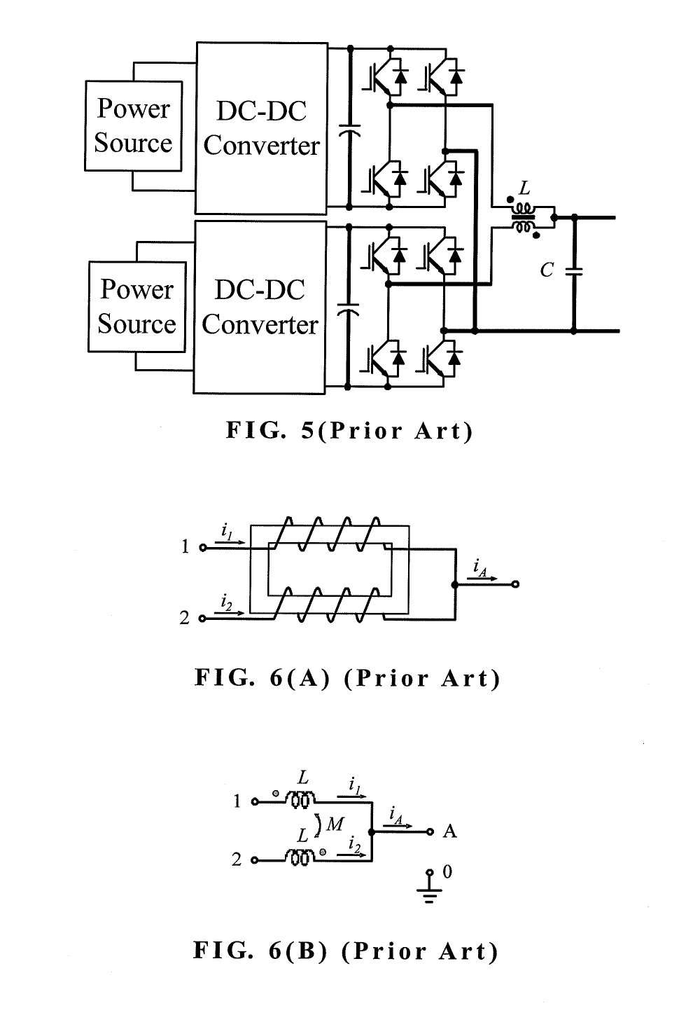

### DETAILED DESCRIPTION OF THE PREFERRED EMBODIMENT

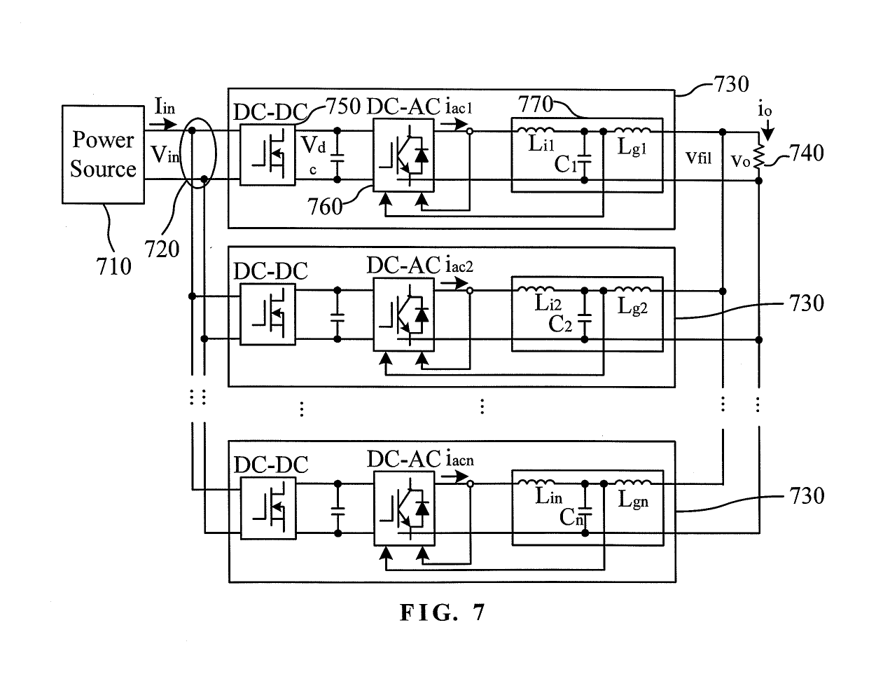

FIG. 7 is a schematic view illustrating a paralleled power conditioning system, which includes a power source 710, an input terminal 720, a plurality of power conditioning units 730 and a load 740.

The power source 710 is preferably a low voltage fuel cell or other related power source such the solar cell. The input terminal 720 is used to receive an input power outputted by the power source 710. The power conditioning units 730 convert the DC voltage Vin outputted by the power 710 to a AC voltage V0. Each power conditioning unit 730 comprises a DC/DC converter 750, a DC/AC inverter 760 and a filter 770. The load 740 connects to the plurality of power conditioning units 730 in parallel.

The DC/DC converter 750 couples to the input terminal 720 for receiving the input power, so as to convert the power of the input terminal to a DC voltage Vdc. The voltage of the input power is lower than the DC voltage Vdc. The DC voltage Vdc is preferably about 380 volts in this embodiment, and therefore the DC/DC converter 750 is a voltage boosting DC/DC converter.

The DC/AC inverter 760 couples to the DC/DC converter 750 for converting the DC voltage Vdc to an AC voltage. The filter 770 couples to the DC/AC inverter 760 for filtering out the noise of the AC voltage and generating a filtering voltage vfil.

The filter 770 is a low-pass filter composed of an input inductor Lᵢₖ, a capacitor Cₖ, and an output inductor L_{gk}, wherein 1≦k≦n, n and k each is an integer number.

The DC/AC inverter 760 has current feedback and voltage feedback. Referring to FIG. 7, the current feedback is generated by measuring the current i_{ack} passed through the input inductor Lᵢₖ, and the voltage feedback is generated by measuring a voltage of the capacitor Cₖ.

As shown in FIG. 7, because the output inductor L_{gk} does not have any coupled magnetic field, the circuit diagram shown in the FIG. 7 is a non-coupled LCL type filter based on the paralleled power conditioning system. The aforementioned type of filter has a simple structure, which requires synchronizing the PWM (Pulse Width Modulation) clocks.

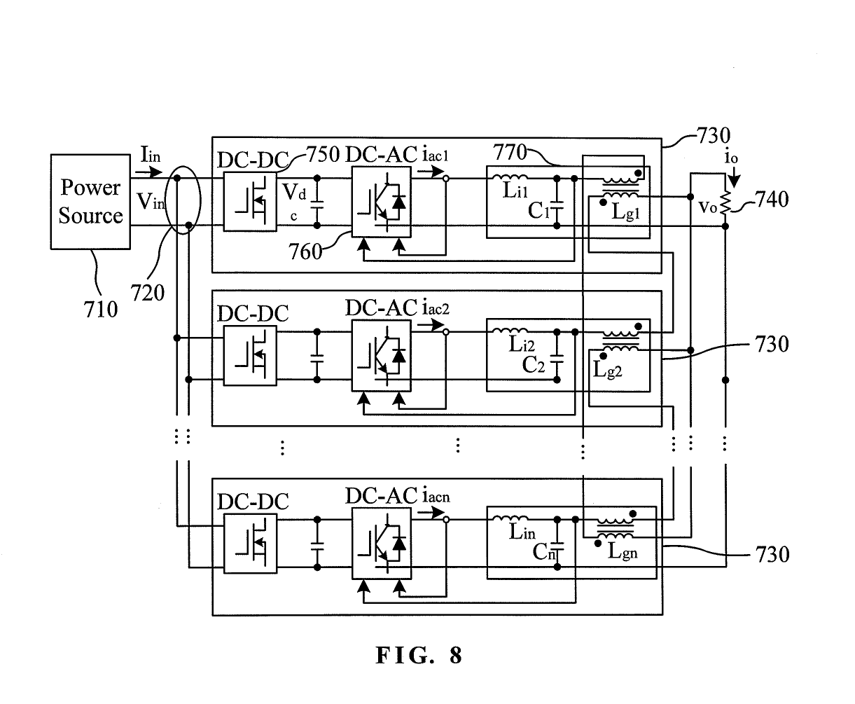

FIG. 8 shows another embodiment illustrating a coupled LCL type filter of the power conditioning system in accordance with the present invention. Referring to FIG. 8, because the output inductor L_{gk} has a coupled magnetic field, the output inductor L_{gk} is operated as a secondary inductor. Thus the output inductor L_{gk} is provided with the function of secondary inductance for coupling the current outputted by the plurality of power conditioning units.

As shown in FIG. 8, the output inductor L_{gk} having a coupled magnetic field is disposed as an interface between two different inverters. In this embodiment, Lᵢ₁, Lᵢ₂ to Lᵢₙ represent the inductors of the first to N-th inverters. C₁, C₂ to Cₙ represent the filtering capacitors of the first to N-th inverters. L_{g1}, L_{g2} to L_{gn} represent the inductors located at load side of the first to N-th inverters. In this embodiment, the circuit has secondary side winding connect to the other phase, and therefore all of the output currents will couple together for increasing mutual inductance between phases without affecting the self inductance, so as to reduce circulating current between phases.

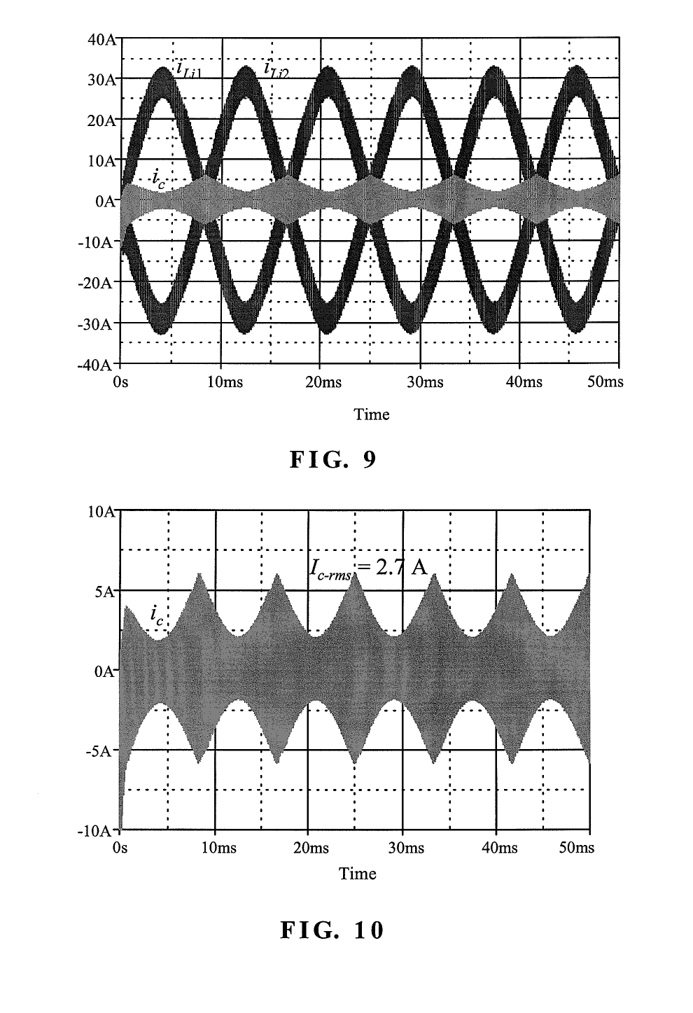

FIG. 9 is a schematic view illustrating a simulation result of the paralleled power conditioning system of the present invention. FIG. 9 shows the circulating current passing through the two non-coupled inverters, wherein the two paralleled inverter PWM clocks are 180 degrees phase shifted. Therefore, while the switching frequency is 20 kHz, the second inverter PWM clock is 25 μs apart from that of the first inverter. The output current generated by each inverter is 20 A rms, and the peak circulating current generated at the zero crossing point is about 6 A. FIG. 10 is a schematic view illustrating the magnified circulating current of the FIG. 9, wherein the R.M.S (root mean square value) of the circulating current is about 2.7 A.

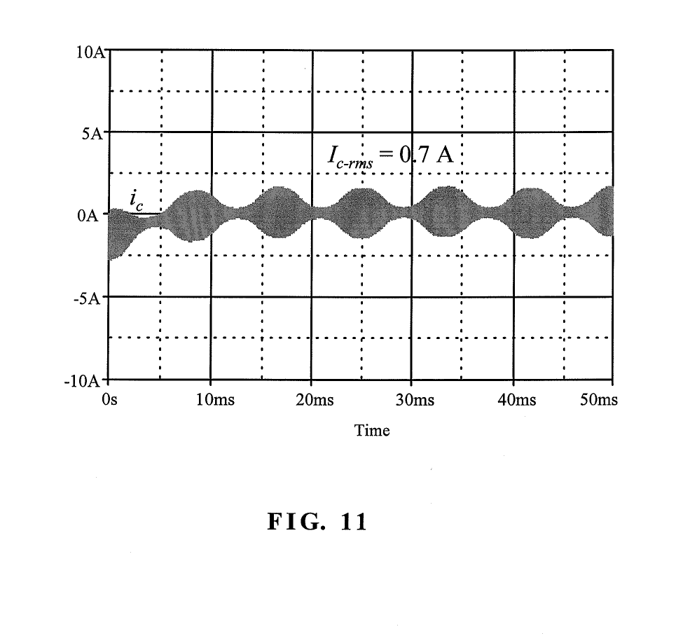

FIG. 11 is a schematic view illustrating simulation result of the FIG. 8. FIG. 11 shows the circulating current passing through the two paralleled inverters with coupled inductors, while the two PWM clocks is 180 degrees apart. The peak circulating current is still generated at zero crossing point, but it degrades to 1.2 A. The R.M.S value of the circulating current is about 0.7 A.

In addition, the LCL type filter 770 of the paralleled inverter can operates at different systems such as fuel cell power conditioning system, PV (Photovoltaic) inverter, or UPS etc. Further, the filter 770 can operates at any quantity of inverters without sharing an inductor core, and therefore the circulating current passing through each individual coupled inductor can be minimized. The LCL type filter 770 is a multi-purposed filter which can operate at individual AC load or utility grid.

From abovementioned FIG. 9 to FIG. 11, it is known that the present invention can reduce circulating current effectively by using individual inductor in the paralleled inverters. In addition, the present invention does not need to utilize any high volume components such switches, input capacitor Cin, inductor Lf or capacitor Cf to increase conversion efficiency thereby reducing manufacturing cost and increasing heat-dissipation efficiency.

Although the present invention has been explained in relation to its preferred embodiment, it is to be understood that many other possible modifications and variations can be made without departing from the scope of the invention as hereinafter claimed.

What is claimed is:

1. A paralleled power conditioning system with circulating current filter, comprising:
an input terminal for receiving an input power;
a plurality of power conditioning units, each unit including:
a DC/DC converter coupled to the input terminal for receiving the input power, so as to convert the input power to a DC voltage;
a DC/AC inverter coupled to the DC/DC converter for converting the DC voltage to a AC voltage; and
a filter coupled to the DC/AC inverter for eliminating noise generated by the AC voltage and circulating current among the power conditioning units, so as to generate a filter voltage; and
a load connected to the plurality of power conditioning units;
wherein the plurality of power conditioning units are connected in parallel to the load.

2. The paralleled power conditioning system as claimed in claim 1, wherein the filter is a low pass filter.

3. The paralleled power conditioning system as claimed in claim 2, wherein the low pass filter comprises an input inductor, a capacitor and an output inductor.

4. The paralleled power conditioning system as claimed in claim 3, wherein the DC/AC inverter is provided with a current feedback and a voltage feedback.

5. The paralleled power conditioning system as claimed in claim 4, wherein the current feedback is generated by measuring current passing through the input inductor.

6. The paralleled power conditioning system as claimed in claim 4, wherein the voltage feedback is generated by measuring voltage of the capacitor.

7. The paralleled power conditioning system as claimed in claim 3, wherein the output inductor comprises a coupled magnetic field for coupling output currents of the plurality of power conditioning units.

8. The paralleled power conditioning system as claimed in claim 7, wherein the output inductor is as a secondary inductance for coupling output currents of the plurality of power conditioning units.

9. The paralleled power conditioning system as claimed in claim 1, wherein voltage of the input power is smaller than the DC voltage.

10. The paralleled power conditioning system as claimed in claim 9, wherein the input power is generated by a low voltage fuel cell or a solar photoelectric module.
